(19) United States
(12) Patent Application Publication
(10) Pub. No.: US 2008/0102418 A1
(43) Pub. Date: May 1, 2008

(54) ROTARY HAND TOOL

(76) Inventor: Glenn Krieger, Seattle, WA (US)

Correspondence Address: BLACK LOWE & GRAHAM, PLLC, 701 FIFTH AVENUE, SUITE 4800, SEATTLE, WA, 98104, US

(21) Appl. No.: 11/554,932

(22) Filed: Oct. 31, 2006

(51) Int. Cl. A61C 1/02; A61C 1/05

(52) U.S. Cl. 433/98; 433/132

(57) ABSTRACT

A fluid-driven rotary hand tool for rotating a bit is provided. The hand tool includes a handle and a head attached to the end of the handle. A shaft is rotatably secured within the head and configured to hold a bit at one end thereof. The fluid drive is operatively engaged with the shaft for rotation relative to the head. The speed transducer is operatively coupled to the shaft for creating a signal indicative of the speed of the shaft. A thrust transducer is also operatively coupled to the shaft. The thrust transducer creates a signal indicative of the axial thrust on the shaft as the hand tool is being used. A variable speed controller including a valve operatively coupled to the drive is provided. While the speed may be controlled by the variable speed controller, a control unit is provided and connected to the speed transducer and the valve to maintain the speed within a preset range. The visual indicator is employed that receives the signal indicative of the speed and displays a reading representative thereof. An indicator of thrust is also disclosed.

### FIELD OF THE INVENTION

The present invention relates to fluid-driven tools, and more particularly to a hand-held dental instrument with a variable-speed fluid drive.

### BACKGROUND OF THE INVENTION

Hand-held dental instruments, such as drills, commonly include a fluid drive mechanism utilizing compressed air passing through a vane-type fluid drive mechanism. A foot pedal is commonly used to control an air valve to allow variable rotational speed of the dental instrument. An example of such a dental console setup is disclosed in U.S. Pat. No. 3,949,480 granted to Page.

The unit disclosed utilizes a single foot pedal with multiple dental instruments, such as drills, that may be operated with the foot pedal. The dentist holds the instrument by a handle, the instrument being connected to the main console. The pressurized air enters through tubing extending from the back end of the instrument handle in response to variations in the position of the foot pedal. Where control of the driven instrument is based upon a position of the foot, the foot must be allowed to move as the use of the instrument will dictate. Such movement often compromises the posture of the operator. Additionally, the mechanism necessary to link the foot pedal to the valve is cumbersome and difficult to move when necessary for cleaning or for the sake of the posture of the operator. Fluid drives, nonetheless, enjoy tremendously advantageous ratios of weight to power and volume to power and have gained very wide acceptance among those working in the delicate confines of a patient's mouth.

Such instruments have proven to be quite useful in the hands of the skilled dental practitioner. However, even for the experienced practitioner, it may be difficult to discern the actual speed of the drill while in use. When pressure is applied to the drill during use, the speed will invariably decrease without any change in position of the foot pedal.

A relationship exists between a volume of air admitted through the tubing at a pressure, a pitch of the vanes within the instrument drive, the torque which the driven instrument exerts, and the rotational speed of the driven instrument. A great deal of experience is necessary to judge the rotational speed of the driven instrument based upon pedal position. Because of variability in the response of the instrument to the admitted air, even skilled practitioners experience some difficulty in generating reproducible results based solely upon pedal position.

In addition to the inherent variability of the driven instrument, variability in the instrument also results where leaks in hoses or other variability in the air supply is also introduced. Restrictions in hoses also can impair the predictability of the instrument when driven.

In addition to variability within the instrument mechanism, the use of the instrument causes variability in driven rotational speed. Pressing a rotating drill bit against a surface for drilling will slow the rotation of the drill bit. The amount of axial thrust on the tool being rotated in the dental instrument is also difficult to ascertain. Such thrust affects rotational speed and delicate operations.

Another problem encountered with the use of such dental instruments and consoles is the requirement for tubing or cables to extend from the foot pedal to the console. These may be extending along the floor and create obstacles for dentists, assistants and technicians. Furthermore, if the tubes pass air through them, any pinching of the tube may result in decreased effectiveness of the dental tools.

Thus, there remains an unmet need for hand-held tools that are fluid driven and yet are more controlled in terms of speed and thrust.

### SUMMARY OF THE INVENTION

The present invention provides a fluid-driven rotary tool for rotating a bit, such as for use with a dental instrument. The tool preferably includes a handle, a head, a shaft within the head, a fluid drive, speed and thrust transducers, and a variable speed controller. The head is attached to the end of the handle. The shaft is rotatably secured within the head and configured to hold a bit at one end thereof. The fluid drive is operatively engaged with the shaft for rotation relative to the head. The speed transducer is operatively coupled to the shaft for creating a signal indicative of the speed of the shaft. The transducer is preferably a sensor that detects the shaft rotational speed. The thrust transducer is also preferably a sensor. The thrust transducer is operatively coupled to the shaft to create a signal indicative of the axial thrust of the shaft as the hand tool is being used. The variable speed controller includes a valve operatively coupled to the drive. Thus, by opening and closing the valve, the speed of the drive can be changed.

A preferred embodiment includes a control unit interconnected with both the speed transducer and the valve. The control unit allows the user to set a speed limit to keep the speed of the drive, and thereby the shaft, within a predetermined range. The control unit preferably includes both an upper limit and a lower limit. The user may set the upper limit such that the variable speed controller will not increase the speed above the user-selected, preset upper limit. Likewise, the user can set the lower limit controller to ensure that the speed does not decrease below the lower limit regardless of the input from the variable speed controller and the frictional resistance on the drill.

Additionally, because only logic levels of both current and voltage are used to monitor the rotation of the driven instrument, no possibility for endangering the patient exists even if conductors are exposed. Fluid supply hoses are substantially more flexible and lighter than electrical conductors necessary to convey comparable power to an electrical motor suitably sized to drive a drill bit. As a result, the preferred embodiment allows the operator greater control, placing less pressure on the instrument in operation.

The preferred embodiment further includes a visual indicator that receives the signal indicative of the speed. The indicator displays a reading representative of the speed. Such representation may be in the form of a bar graph, a dial gauge, a series of lights of the same, or different colors. The speed may alternatively be indicated in audible or sensory manner other than visual.

Likewise, a visual indicator to indicate the level of thrust may also be provided. Thrust may alternatively be indicated by an audible or other sensory response signal.

The variable speed controller preferably includes a foot pedal that has a wireless connection to the console to which the hand tool is connected. A rheostat within the foot pedal may preferably be used with a signal indicative of the rheostat input being transmitted to the control unit with proper actuation of the valve to maintain the desired speed of the rotary hand tool.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1, is a side-elevational view of a dental instrument hand tool in accordance with the invention;

FIG. 1A is a partial-sectional view of the head and neck of the hand tool illustrated in FIG. 1 showing the internal working components in semi-schematic fashion;

FIG. 2 is a schematic view of the control inputs and outputs for the tool; and

FIG. 3 is a plan view of the control unit user interface.

### DETAILED DESCRIPTION OF THE INVENTION

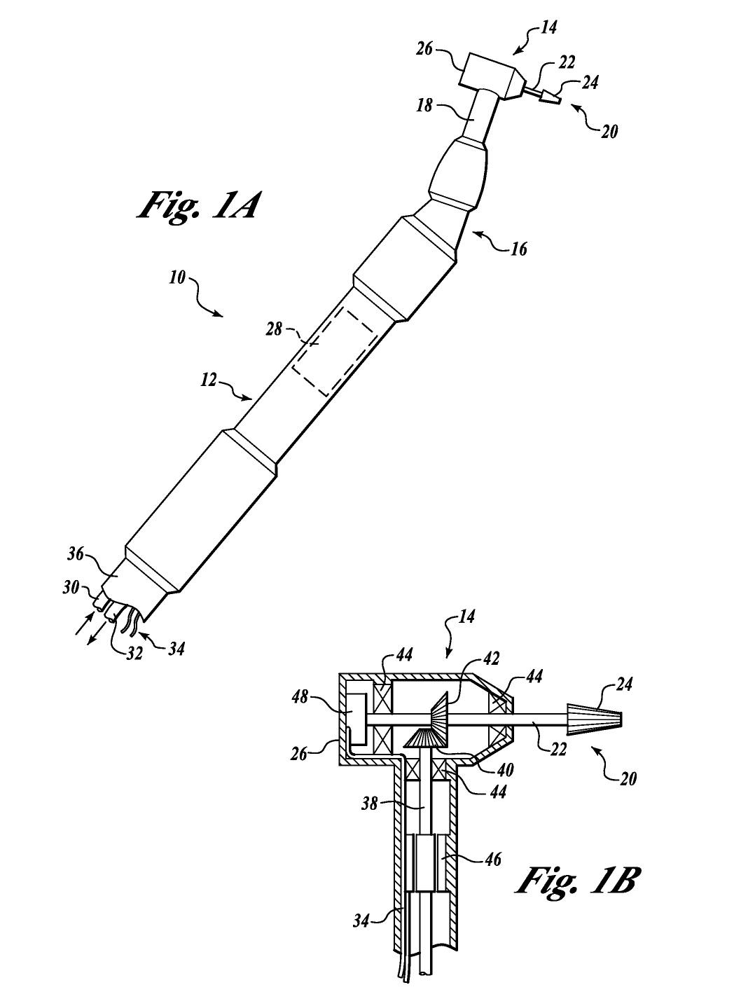

Referring to FIG. 1, a preferred embodiment of the fluid driven rotary tool is illustrated as a hand tool 10. Hand tool 10 includes a handle 12, a head 14, an elbow 16 and a neck 18. The elbow 16 is situated between handle 12 and neck 18 with neck 18 connecting head 14. While the illustrated arrangement is common in dental instruments, other arrangements and hand-tool configurations may be used.

Head 14, the working end of the instrument, holds a bit 20. Bit 20 includes a bit shaft 22 and a bit head 24. Bit shaft 22 extends from within head 14 and preferably has bit head 24 secured to the end thereof. Bit head 24 is used for grinding, drilling, buffing, or other operations such as may be useful, for example, to a dentist working on patients' teeth. However, bit head 24 and hand tool 10 may alternatively be employed in other uses such as for a hobby tool. A butt 26 is situated at the opposite end of head 14 from bit 20.

The invention is preferably for use with a fluid-driven rotary hand tool. Thus, a fluid-driven turbine 28 may be used and will not be described in detail here. Fluid-driven turbine 28 uses a fluid such as a liquid or gas with a fluid input tube 30 extending within the handle 12 and a fluid exit tube 32. The fluid drive preferably includes a vane-type drive mechanism. The fluid drive mechanism may be situated within handle 12, or remotely within a separate console or control unit, with, for example, an extending cable drive from such console to hand tool 10. An electrical conduit 34 also may run within handle 12 all the way to head 14 through elbow 16 and neck 18 to receive input from sensors and to control valve mechanisms as described hereinafter. A sheath tube 36 preferably functions as a conduit to enclose and route fluid input tube 30, fluid exit tube 32 and electrical conduit 34. Electrical conduit 34 may include multiple electrical wires as needed for the various sensors and operating components. Fluid-driven turbine 28 preferably includes an electrically controlled valve to drive the speed of fluid-driven turbine 28 and thus bit shaft 22 operatively connected thereto. Alternatively, the valve may be housed in a console or control unit to regulate the fluid passing through fluid input tube 30.

Referring to FIG. 1A the internal workings of the thrust and speed transducers will now be described. Within neck 18, a drive shaft 38 extends from fluid-driven turbine 28. Drive shaft 38 may extend all the way to fluid-driven turbine 28, or may have an inter-connection in order to turn at elbow 16. In any case, fluid-driven turbine 28 is operatively coupled with drive shaft 38 to rotate drive shaft 38. An input gear 40 is secured to the end of drive shaft 38 within head 14. Input gear 40 engages an output gear 42 in order to drive bit shaft 22 about its axis. Gears 40 and 42 are preferably bevel gears, so as to transfer shaft rotation to a different axis. Bit shaft 22 may extend externally of head 14 and include a working bit head 24 on the end thereof. Alternatively, bit shaft 22 may simply have a chuck at the end thereof (opposite butt 26) for securing differing bits 20 depending on the needs of the user. Bearings 44 are secured in standard fashion at various locations to hold drive shaft 38 and bit shaft 22 properly.

A speed transducer 46 is preferably operatively coupled to drive shaft 38. Speed transducer 46 is a sensor that detects the rotational speed of drive shaft 38. Electrical wires are secured thereto so that such signal may be transferred back to a control unit to be described below. Speed transducer 46 may be an induction type sensor, such as a Hall Effect sensor. Other magnetic induction type sensors may be used or any other rotation or angular speed sensors. Furthermore, speed transducer 46 may be secured to other shafts entrained within the operative mechanism, such as bit shaft 22. All such altering embodiments will function as intended as long as they provide a speed indication signal representative of the rotational speed of bit shaft 22.

A thrust transducer 48 is also preferably provided within head 14 at the butt end 26 of head 14. Thus, thrust transducer 48 is axially aligned with bit shaft 22 to be able to sense thrust along the axis of bit shaft 22. Thrust transducer 48 may be any of a variety of sensors, such as a strain gauge, or a piezo-electric sensor. A piezo-electric sensor, for example, would operate by having a pressure plate applied against one side thereof to receive the axial thrust of bit shaft 22. Pressure applied against the piezo-electric material would change the induced voltage across the material, from one side to the other, in a manner that could be detected electrically to sense thrust (proportional to the voltage across the piezo-electric material). The thrust transducer 48 could alternatively be positioned in a different part of hand tool 10. For example, the side force against drive shaft 38 could be measured by placing a thrust transducer between neck 18 and bearings 44 that holds drive shaft 38. Such a side force could be transmitted between gears 40 and 42. Various other alternate methods and apparatuses can be employed. Thrust transducer 48 would preferably include electrical inter-connections that extend through handle 12 and sheath tube 36 back to a control unit or console.

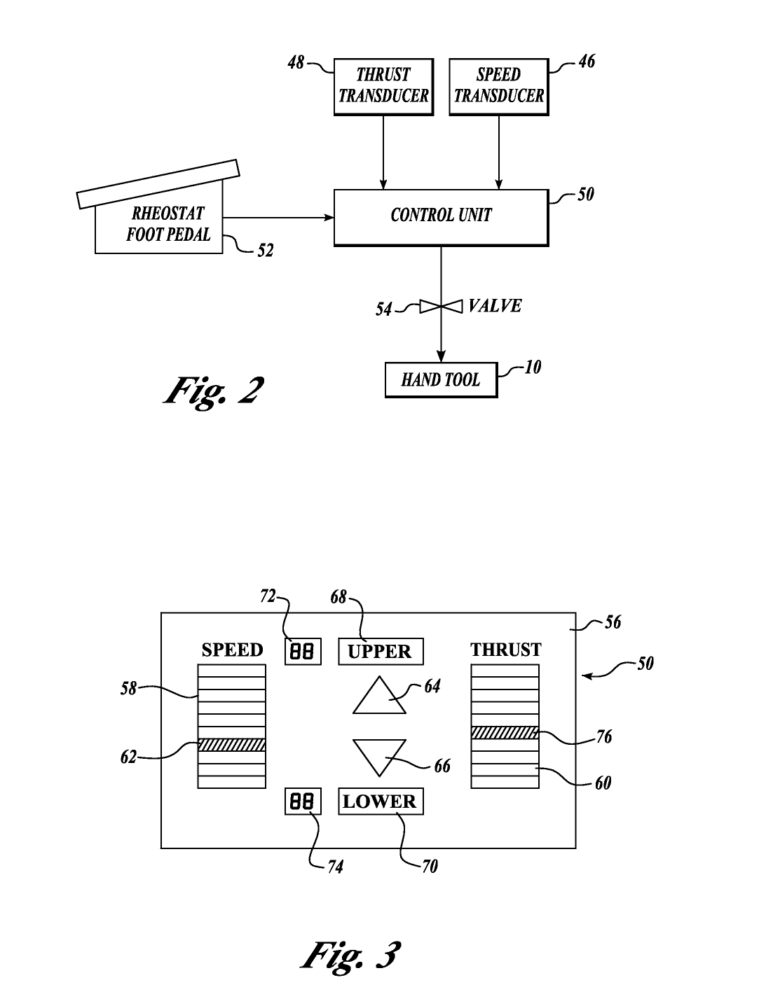

FIG. 2 is illustrative of the interaction of thrust transducer 48, speed transducer 46, and a control unit 50. Control unit 50 includes appropriate electronics for speed control of hand tool 10 and to provide desired indicia of speed and thrust. Speed limits may also be set by control unit 50. The preferred apparatus for variable speed input is a foot pedal 52. Foot pedal 52 may include a rheostat therein and a wireless transmitter for sending the appropriate signal to control unit 50. Alternatively, foot pedal 52 may be hardwire connected to control unit 50. Another alternative would be for foot pedal 52 to have a valve mechanism therein with a fluid conduit extending into foot pedal 52, with pedal 52 controlling the flow of air with appropriate valves. In any of these cases, foot pedal 52 provides input to control unit 50. Control unit 50 operates the opening and closing of a valve 54 to control the speed of hand tool 10. Valve 54 controls the flow of fluid to fluid-driven turbine 28 as directed by control unit 50. Control unit 50 may open or close valve 54 depending on preset inputs and certain limits and the input of speed transducer 46, thrust transducer 48 and foot pedal 52.

A preferred embodiment for interfacing control unit 50 is illustrated in FIG. 3. Control unit 50 preferably includes a housing 56 with a speed gauge 58 and a thrust gauge 60. Speed gauge 58 includes a speed indicator bar 62 with adjust and limit buttons. An upper adjust button 64 may be used to increase the upper and lower speed range values. Conversely, a lower adjust button 66 may be used to decrease the upper and lower speed range. An upper limit button 68 is pressed to select the upper limit after which upper and lower adjust buttons 64 and 66 may be employed to vary the limit for the upper range as desired. Likewise, a lower limit button 70 may be pressed, after which upper and lower adjust buttons 64 and 66 may be used to define the lower end of the allowable speed range. Upper and lower numeric indicators 72 and 74 may be used to help set the desired range. Thrust gauge 60 may include a thrust indicator bar 76 that moves up or down depending on the thrust sensed by thrust transducer 48. The sensitivity of thrust gauge 60 may be adjusted.

To use the device of the present invention, such as by a dentist with a dental rotary tool, the dentist may press upper limit button 68, then press upper and lower adjust buttons 64 and 66 to define a proper maximum speed, which will be presented in upper numeric indicator 72. The dentist can do likewise after pressing lower limit button 70 to select a lower speed indicated by lower numeric indicator 74. With the dentist pressing on the foot pedal 52, the speed will be kept within this desired range. The control unit 50 will keep the speed within this range, even when bit head 24 encounters resistance. Should the dentist remove all pressure from foot pedal 52, hand tool 10 will stop. An indication of the actual speed may be seen on speed gauge 58 as the dentist uses hand tool 10. The thrust may be seen on thrust gauge 60 as hand tool 10 is being used. Alternatively, since the user of hand tool 10 would like to keep his/her eyes focused on the work, alternate sensory indicators may be employed. Thus, control unit 50 may have speakers therein that emit sounds indicative of the speed and/or thrust of hand tool 10. In one preferred embodiment, the user simply sets the upper and lower limits on the speed, thus knowing that the speed will be maintained within those limits once hand tool 10 is actuated by the foot pedal 52 and an audible note is played through a speaker in the control unit 50 to indicate the thrust. Such an auditory signal may alternatively be sounded in the ear of the user, rather than through a speaker in the control unit 50.

With the above described system, the user may be able to maintain better control of rotary hand tool 10. This is accomplished by maintaining speed within a defined range when rotation is desired. When the user lifts their foot from the foot pedal 52 entirely, the speed is reduced to zero. Thrust indication may also help the user apply proper force to hand tool 10.

While preferred embodiments of the invention have been illustrated and described, it will be appreciated that various changes can be made therein without departing from the spirit and scope of the invention.

1. A fluid-driven rotary tool for rotating a bit, said tool comprising:
a) a handle;
b) a head attached to the end of said handle;
c) a shaft rotatably secured within said head, said shaft being configured to hold the bit at one end thereof,
d) a fluid drive operatively engaged with said shaft for rotation relative to said head;
e) a speed transducer operatively coupled to said shaft for creating a signal indicative of the speed of said shaft; and
f) a variable speed controller including a valve operatively coupled to said fluid drive.

2. The tool of claim 1, further comprising a control unit interconnected with said speed transducer and with said valve, said control unit having a speed limit setting to keep the speed within a predetermined range.

3. The tool of claim 2, wherein said control unit includes an upper limit above which said variable speed controller will not increase the speed.

4. The tool of claim 2, wherein said control unit includes a lower limit below which said variable speed controller will not decrease the speed.

5. The tool of claim 4, wherein said control unit includes an upper limit above which said variable speed controller will not increase the speed.

6. The tool of claim 1, further comprising a thrust transducer operatively coupled to said shaft, for creating a signal indicative of the axial thrust on said shaft as the hand tool is being used.

7. The tool of claim 6, further comprising a visual indicator that receives said signal indicative of the speed, said indicator displaying a reading representative of the speed.

8. The tool of claim 6, further comprising an audible indicator that receives said signal indicative of the thrust, said indicator creating a sound representative of the thrust.

9. The tool of claim 6, further comprising a control unit interconnected with said speed transducer and with said valve, said control unit having a speed limit setting to keep the speed within a predetermined range.

10. The tool of claim 9, wherein said control unit includes a visual interface, said interface receiving the signals indicative of the speed and the thrust, and displaying a visual representation of the speed and the thrust on said interface.

11. The tool of claim 1, further comprising a visual indicator that receives said signal indicative of the speed, said indicator displaying a reading representative of the speed.

12. The tool of claim 1, wherein said variable speed controller comprises a wireless controller removed from the hand tool.

13. The tool of claim 12, wherein said wireless controller comprises a foot pedal.

14. A hand tool for rotating a bit, said tool comprising:
a) a handle;
b) a head attached to the end of said handle;
c) a shaft rotatably secured within said head, said shaft being configured to hold the bit at one end thereof,
d) a drive operatively engaged with said shaft for rotation relative to said head;
e) a thrust transducer operatively coupled to said shaft, for creating a signal indicative of the axial thrust on said shaft as the hand tool is being used; and
f) a variable speed controller.

15. The tool of claim 14, wherein the tool comprises a dental drill and wherein said drive comprises a fluid drive.

16. The tool of claim 15, further comprising a speed transducer operatively coupled to said shaft for creating a signal indicative of the speed of said shaft.

17. The tool of claim 16, further comprising a control unit interconnected with said speed transducer and with said drive, said control unit having a speed limit setting to keep the speed within a predetermined range.

18. The tool of claim 14, further comprising a visual indicator that receives said signal indicative of the thrust, said indicator displaying a reading representative of the thrust.

19. The tool of claim 14, further comprising an audible indicator that receives said signal indicative of the thrust, said indicator creating a sound representative of the thrust.

20. The tool of claim 14, further comprising a speed transducer operatively coupled to said shaft for creating a signal indicative of the speed of said shaft.

21. The tool of claim 20, further comprising a visual indicator that receives said signal indicative of the speed, said indicator displaying a reading representative of the speed.

22. The tool of claim 20, further comprising an audible indicator that receives said signal indicative of the speed, said indicator creating a sound representative of the speed.

23. A fluid-driven rotary hand tool for rotating a bit, said hand tool comprising:
a) a handle;
b) a head attached to the end of said handle;
c) a shaft rotatably secured within said head, said shaft being configured to hold the bit at one end thereof,
d) a fluid drive operatively engaged with said shaft for rotation relative to said head;
e) a speed transducer operatively coupled to said shaft for creating a signal indicative of the speed of said shaft;
f) a thrust transducer operatively coupled to said shaft, for creating a signal indicative of the axial thrust on said shaft as the hand tool is being used; and
g) a variable speed controller including a valve operatively coupled to said drive.

24. The rotary hand tool of claim 23, further comprising a control unit interconnected with said speed transducer and with said valve, said control unit having a speed limit setting to keep the speed within a predetermined range.

25. The rotary hand tool of claim 24, further comprising a visual indicator that receives said signal indicative of the speed, said indicator displaying a reading representative of the speed.

26. A rotary dental instrument comprising:
a) a handle;
b) a head attached to the end of said handle;
c) a shaft rotatably secured within said head;
d) a fluid drive operatively engaged with said shaft for rotation relative to said head; and
e) a variable speed controller operatively coupled to said drive, wherein said variable speed controller comprises a wireless controller removed from the hand tool.

27. The rotary dental instrument of claim 26, wherein said variable speed controller comprises a rheostat.

28. The rotary dental instrument of claim 27, wherein said variable speed controller comprises a foot pedal operatively connected with said rheostat.

29. The rotary dental instrument of claim 26, further comprising a speed transducer operatively coupled to said shaft for creating a signal indicative of the speed of said shaft.

30. The rotary dental instrument of claim 29, further comprising a thrust transducer operatively coupled to said shaft, for creating a signal indicative of the axial thrust on said shaft as the dental instrument is being used.

31. The rotary dental instrument of claim 29, further comprising a visual indicator that receives said signal indicative of the speed, said indicator displaying a reading representative of the speed.

32. A method of operating a rotary hand tool comprising:
a) providing a fluid-driven rotary hand tool with a fluid drive mechanism, said tool including a drive shaft operatively coupled to said fluid drive mechanism and a bit operatively coupled to said drive shaft;
b) providing a variable speed controller including a valve to control the flow of fluid to said fluid drive mechanism to control the speed of said fluid drive mechanism and thereby the speed of said drive shaft;
c) providing a speed transducer configured to produce a signal indicative of the speed of said drive shaft; and
d) operating said tool with said variable speed controller within a predetermined speed range indicated by said signal from said speed transducer.

33. The method of claim 32, further comprising a control unit interconnected to said speed transducer and said variable speed controller, said control unit operating said valve to maintain the speed of the drive shaft within a predetermined range when operated.

34. The method of claim 33, wherein said control unit includes a user interface for inputting values for a predetermined speed range, further comprising the step of inputting values for a speed range before operating said tool.

35. The method of claim 34, wherein said control unit includes visual indicia of the speed of said drive shaft.

36. The method of claim 33, further comprising providing a thrust transducer operatively coupled to said bit for sensing the thrust on said bit and sending a signal to said control unit relating to the thrust on said bit in operation.

37. The method of claim 36, wherein said control unit provides a user-sensible indication of thrust.

38. The method of claim 37, wherein said indication of thrust includes an audible indicator.
